(19) United States
(12) Patent Application Publication
(10) Pub. No.: US 2007/0267264 A1
(43) Pub. Date: Nov. 22, 2007

(54) Overrunning Clutch

(76) Inventor: Jack Eric Pederson, Saline, MI (US)

Correspondence Address: DYKEMA GOSSETT PLLC, 39577 WOODWARD AVENUE, SUITE 300, BLOOMFIELD HILLS, MI, 48304-5086, US

(21) Appl. No.: 11/750,733

(22) Filed: May 18, 2007

Related U.S. Application Data
(63) Continuation-in-part of application No. 11/419,383, filed on May 19, 2006.

(51) Int. Cl. F16D 41/064; F16D 15/00

(52) U.S. Cl. 192/45; 192/113.32

(57) ABSTRACT

An overrunning clutch is provided that facilitates the use of grease lubrication and use of the clutch in high speed and/or high torque applications. In accordance with one aspect of the invention, a seal is disposed between the rollers in the clutch and a bearing that is disposed between the input and output members and the inner raceway, outer cam surfaces, rollers and bearing are lubricated with grease. In accordance with another aspect of the invention, the mass of the rollers and the stiffness of the springs acting on the rollers are selected to provide a high natural frequency for the roller and spring system to enable the clutch to better withstand torsional vibration in high speed and/or high torque applications.

This application claims priority to and is a continuation-in-part of U.S. patent application Ser. No. 11/419,383 filed May 19, 2006, the entire disclosure of which is incorporated herein by reference.

### BACKGROUND OF THE INVENTION

1. Field of the Invention

This invention relates to overrunning clutches and, in particular, to overrunning clutches having improved structures that facilitate grease lubrication of the clutch and/or use of the clutch in high speed and/or high torque applications.

2. Discussion of Related Art

Rotational coupling devices such as clutches are used to control transfer of torque between rotational bodies. An overrunning clutch is designed to drive in one direction while freewheeling or overrunning in the opposition direction. In the driving direction, the clutch also freewheels if the rotational speed of the driven body exceeds the rotational speed of the driving body. One of the benefits of an overrunning clutch is that it allows for the overrunning of large inertia loads upon stopping and prevents any back-driving damage that may occur to the drive system. Overrunning clutches are commonly used in applications such as dual motor/engine drives, conveyors belts, creep and starter drives and the disengagement of centrifugal masses.

The bearing and friction surfaces of overrunning clutches are provided with lubricant, such as grease, to reduce friction and heat. In conventional overrunning clutches, however, the grease can degrade prematurely into its individual components and can cause the energizing mechanism of the clutch (typically spring loaded plungers or cages) to seize and even fail.

The components in conventional overrunning clutches—particularly rollers and springs—are also subject to damage from vibration in certain applications. For example, torsional vibrations produced by a vehicle engine can cause destructive vibrations in the clutch rollers and springs—particularly where the engine produces vibrations at the resonsant frequency of the combined roller/spring system. The tendency in conventional clutches to place the cam surface on the inner race further exacerbates the vibrational problem because the rollers and springs oscillate with the engine crank shaft. To address these problem, conventional clutches are designed to allow each roller in the clutch to carry the maximum engine torque load (regardless of the downstream torque requirements) or are torsionally tuned. In each case, the resulting clutch is designed with a service factor far in excess of the required torque capacity. These conventional clutches are therefore relatively large, heavy and expensive.

The inventors herein have recognized a need for a clutch that will minimize and/or eliminate one or more of the above-identified deficiencies.

### SUMMARY OF THE INVENTION

The present invention provides an overrunning clutch.

An overrunning clutch in accordance with one embodiment of the present invention includes a hub disposed about an axis of rotation and defining an inner race. A driven member is supported on the hub by a bearing. The driven member defines a radially inner surface spaced from the inner raceway. An outer race is disposed between the radially inner surface of the driven member and the inner raceway of the hub. The outer race has a radially inner surface that defines a plurality of cam surfaces opposing the inner raceway. A plurality of rollers are disposed between the inner raceway and outer race. The clutch further includes a plurality of springs. Each spring of the plurality of springs urges a corresponding roller into engagement with a corresponding cam surface in the outer race. Finally, the clutch includes a seal disposed axially between the rollers and the bearing. The inner raceway, the plurality of cam surfaces, the rollers and the bearing are lubricated with grease.

An overrunning clutch in accordance with one embodiment of the present invention includes a hub disposed about an axis of rotation and defining an inner raceway. The clutch further includes a driven member supported on the hub by a bearing, the driven member defining a radially inner surface spaced from the inner raceway. The clutch further includes an outer race disposed between the radially inner surface of the driven member and the inner raceway of the hub, the outer race having a radially inner surface defining a plurality of cam surfaces opposing the inner raceway. The clutch further includes a plurality of rollers disposed between the inner raceway and the outer race and a plurality of springs, each spring of the plurality of springs urging a corresponding roller into engagement with a corresponding cam surface in the outer race. A first roller of the plurality of rollers has a relatively low mass and a first spring of the plurality of springs has a relatively high spring constant such that a natural frequency of the combined system defined by the first roller and the first spring is relatively high and, in particular, at least 300 Hz.

An overrunning clutch in accordance with the present invention represents an improvement over conventional overrunning clutches. In particular, the inventive clutch facilitates the use of grease lubrication in the clutch through improved lubricant retention and the use of an energizing mechanism (in the form of a loose roller mechanism) that better withstands degradation of the lubricant. An overrunning clutch in accordance with the present invention also allows use overrunning clutches in high speed and/or high torque applications without requiring the clutch to be designed for excess torque capacity thereby enabling the use of smaller, lighter, and less expensive clutches.

These and other advantages of this invention will become apparent to one skilled in the art from the following detailed description and the accompanying drawings illustrating features of this invention by way of example.

### BRIEF DESCRIPTION OF THE DRAWINGS

FIG. 1 is a diagrammatic view of a power transmission assembly incorporating an overrunning clutch in accordance with the present invention.

FIG. 2 is a cross-sectional view of an overrunning clutch in accordance with one embodiment of the present invention.

FIG. 3 is an enlarged sectional view of a portion of an overrunning clutch in accordance with one embodiment of the present invention.

FIG. 4 is a partial cross-sectional view of a portion of an overrunning clutch in accordance with one embodiment of the present invention.

FIG. 5 is a plan view of an overrunning clutch in accordance with another embodiment of the present invention.

FIG. 6 is a cross-sectional view of the overrunning clutch of FIG. 5 taken along lines 6-6.

FIG. 7 is a cross-sectional view of the overrunning clutch of FIG. 5 taken along lines 7-7.

FIG. 8 is a cross-sectional view of the overrunning clutch of FIGS. 6 taken along lines 8-8.

FIG. 9 is a cross-sectional view of the overrunning clutch of FIGS. 6 taken along lines 9-9.

### DETAILED DESCRIPTION OF EMBODIMENTS OF THE INVENTION

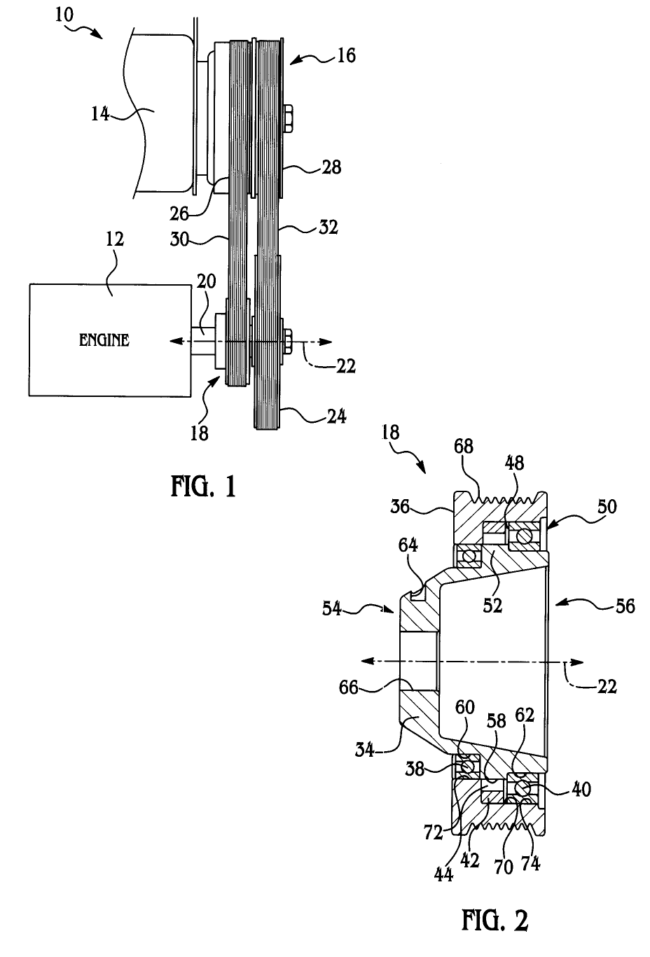

Referring now to the drawings wherein like reference numerals are used to identify identical components in the various views, FIG. 1 illustrates a power transmission assembly 10. Assembly 10 includes an engine 12, at least one accessory device 14, a clutch 16 mounted to device 14, and an overrunning clutch 18 in accordance with the present invention. Assembly 10 is provided to transmit power from a power source such as engine 12 to accessories such as device 14. Assembly 10 may find particular application in vehicles in which engine power is used to drive accessory devices such as alternators, air conditioners, pumps and other devices. It should be understood, however, that assembly 10 may be used in a wide variety of applications.

Engine 12 provides a driving torque and is conventional in the art. Engine 12 may comprise an internal combustion engine and includes a crankshaft 20 extending therefrom along a rotational axis 22. Crankshaft 20 supports clutch 18 and a pulley 24.

Device 14 may assume a wide variety of forms and perform a wide variety of functions depending on the application of assembly 10. In the illustrated embodiment, device 14 comprises an air pump for use in supplying pressurized air to various vehicular systems (e.g., brakes). Device 14 may alternatively comprise, for example only, various fluid pumps, fans, an alternator, or a vehicle air conditioning unit.

Clutch 16 selectively transmits torque from engine 12 to accessory device 14. Clutch 16 is conventional in the art and may comprise an electromagnetic clutch. Clutch 16 includes two pulleys 26, 28 that are coupled to overrunning clutch 18 and pulley 24, respectively, through belts 30, 32. Upon engagement of clutch 16, pulleys 26, 28 (which may function as a rotor and an armature) are brought into engagement for rotation together. In this manner, torque is transmitted from engine 12 through pulley 24 and belt 32 such that accessory device 14 is driven at the same speed as crankshaft 20. Overrunning clutch 18 freewheels during engagement of clutch 16 as discussed in greater detail hereinbelow. Upon disengagement of clutch 16, pulleys 26, 28 disengage from one another and torque is transmitted from engine 12 through clutch 18 and belt 30. In this manner, accessory device 14 may be driven at a lower speed to reduce power consumption.

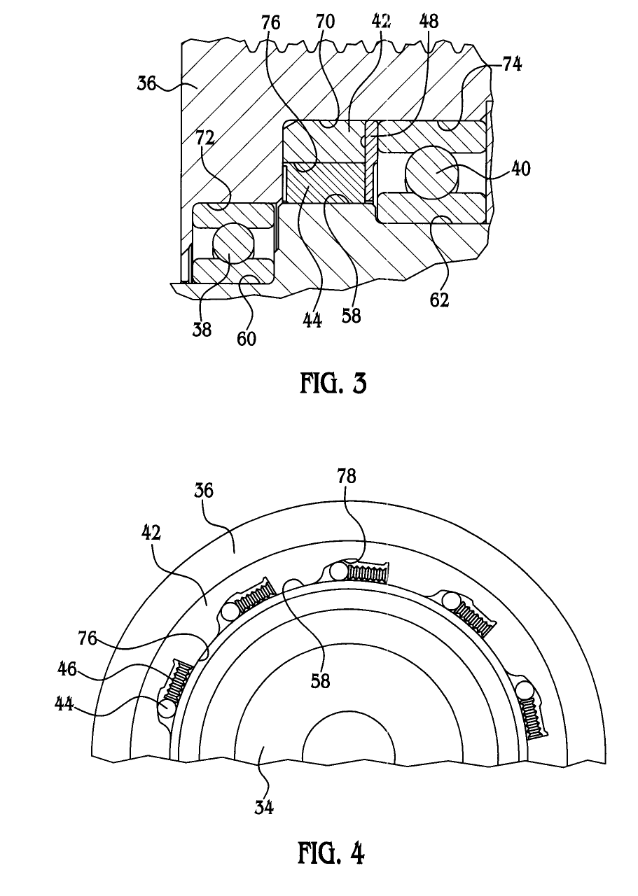

Overrunning clutch 18 is provided to selectively transmit torque from a torque transmitting device, such as engine 12, to a torque receiving device, such as accessory device 14. In power transmission assembly 10, clutch 18 is provided to allow accessory devices to operate at a reduced speed. Referring to FIGS. 2-4, clutch 18 may include a hub 34, a driven member such as pulley 36, bearings 38, 40, an outer race 42, rollers 44, springs 46 and seals 48, 50.

Hub 34 is mounted on crankshaft 20 and is configured to transfer torque to race 42 through rollers 44. Hub 34 is disposed about, and may be centered on, axis 22. Hub 34 has an annular radially outwardly projecting flange 52 intermediate the axial ends 54, 56 of hub 34. Flange 52 defines shoulders against which bearings 38, 40 are disposed. Flange 52 also creates a stepped outer diameter that defines an inner raceway 58 and first and second inner bearing surfaces 60, 62 on either side of raceway 58. The outer diameter of hub 34 at bearing surface 60 is less than the outer diameter of hub 34 at bearing surface 62. Hub 34 tapers towards end 54 and has a substantially conical shape proximate end 54. Hub 34 may include a plurality of circumferentially spaced recesses 64 proximate end 54 for use in removing clutch 18. Recesses 64 may be spaced equidistant from one another. Hub 34 defines a stepped diameter bore 66 configured to receive crankshaft 20. The smaller diameter portion of bore 66 is configured to received a threaded portion of crankshaft 20.

Pulley 36 is provided to transmit torque from outer race 42 to device 14 through belt 30 and pulley 26. Pulley 36 is supported on hub 34 by bearings 38, 40. Pulley 36 defines a plurality of grooves 68 in a radially outer surface configured to grip belt 30. Pulley 36 has a stepped inner diameter that defines a radially inner surface 70 radially spaced from inner raceway 58 and outer bearing surfaces 72, 74 disposed on either side of surface 70 and radially spaced from inner bearing surfaces 60, 62, respectively, of hub 34. The diameter of pulley 36 at surfaces 70, 74 is equal. The diameter of pulley 36 at bearing surface 72, however, is less than the diameter at surfaces 70, 74 and is about equal to the diameter of hub 34 at raceway 58.

Bearings 38, 40 are provided to allow relative rotation of pulley 36 and hub 34 in an overrunning condition. Bearings 38, 40 are conventional in the art and may comprise roller bearings. Bearing 38 is disposed between bearing surfaces 60, 72 while bearing 40 is disposed between bearing surfaces 62, 74.

Outer race 42 transfers torque from rollers 44 to pulley 36. Race 42 is disposed between surface 70 of pulley 36 and raceway 58 of hub 34 and includes a radially inner surface 76 opposing inner raceway 58. Referring to FIG. 4, surface 76 defines a plurality of cam surfaces 78 spaced circumferentially about race 42 and opposing raceway 58. In accordance with one aspect of the present invention, each cam surface 78 is configured to maintain a substantially constant grip angle between: (i) a corresponding roller 44 and surface 78 of outer race 42; and (ii) the roller 44 and inner raceway 58. The grip angle refer to the angle between (a) a straight line extending through the points of contact of roller 44 with raceway 58 and cam surface 78 and (b) a straight line extending through the center of roller 44 and the point of contact of roller 44 with raceway 58 or cam surface 78. The substantially constant grip angle helps to limit the impact of lubricant breakdown and torsional vibration from engine 12 on clutch 18. In accordance with another aspect of the present invention, outer race 42 is press-fit into pulley 36. The press-fit relationship stiffens outer race 42 and preloads race 42 to prevent deflection of race 42 and skidding of rollers 44 and does so at a lower cost compared to conventional clutches.

Rollers 44 are provided to selectively transmit torque between hub 34 and race 42. Rollers 44 are conventional in the art and may be made from conventional metals and metal alloys. Rollers 44 may be circular in cross-section. Rollers 44 are not retained by a cage and clutch 18 is therefore a loose roller clutch. The use of rollers 44 rather than sprags and the loose configuration of rollers 44 rather than using a cage helps to limit the impact of lubricant breakdown and torsional vibration from engine 12 on clutch 18. Rollers 44 remain engaged with both inner raceway 58 and cam surfaces 78 as long as pulley 36 is rotating at the same speed, and in the same direction as hub 34. If pulley 36 begins to rotate at a higher speed than hub 34 or in a different direction, rollers 44 become disengaged from inner raceway 58 and race 42 and pulley 36 are able to freewheel relative to hub 34.

Springs 46 bias rollers 44 into engagement with cam surfaces 78. Springs 46 are conventional in the art and may comprise wave springs or other conventional springs. Springs 46 are inserted in the open space between the inner raceway 58 and cam surfaces 78 and centrifugal forces prevent springs 46 from contacting hub 34. In accordance with one aspect of the present invention, springs 46 act directly on rollers 44 as opposed to driving rollers 44 with spring energized plungers or a cage or other actuating members. This structure permits clutch 18 to better withstand the breakdown of lubricants such as grease and the potential impact of the grease on spring force thereby reducing the possibilities clutch 18 will seize or fail.

Seals 48, 50 are provided to retain lubricant within clutch 18 while reducing the possible frictional impact of the seals. Seals 48 also serves to inhibit lubricant flow between bearing 40 and the working surfaces of clutch 18 (i.e., raceway 58, cam surfaces 78 and rollers 40) to prevent cross-contamination. Seals 48, 50 may comprise labyrinth seals having a tortured flow path formed therein that limits the ability of fluid to escape while limiting the need for direct contact by seals 48, 50 with moving components of clutch 18. Seal 48 is disposed axially between rollers 44 and bearing 40 and also prevents rollers 44 (which again are loose rollers unrestrained by a cage) from contacting and sticking to bearing 40. Seal 50 is disposed on an opposite side of bearing 40 from seal 48. Seals 48, 50 may be made from metal or metal alloys such as steel and may be coated with an anti-friction coating such as manganese phosphate (which also acts as a rust inhibitor).

An overrunning clutch in accordance with the present invention represents a significant improvement relative to conventional clutches. The inventive clutch 18 facilitates the use of grease lubrication in the clutch through improved lubricant retention and the use of an energizing mechanism (in the form of a loose roller mechanism and constant grip angles) that better withstands degradation of the lubricant.

Referring now to FIGS. 5-9, an overrunning clutch 100 in accordance with another embodiment of the present invention is shown. Like clutch 18, clutch 100 is provided to selectively transmit torque from a torque transmitting device, such as engine 12, to a torque receiving device, such as accessory device 14. In power transmission assembly 10, clutch 100 is provided to allow accessory devices to operate at a reduced speed. Clutch 100 may include a hub 102, a driven member such as pulley 104, bearings 106, 108, outer races 110, rollers 112, springs 114, spring retainers 116, a bearing carrier 118, end cap 120, springs 122, plungers 124, a hub 126, pins 128, set screws 130 and fasteners 132.

Hub 102 is mounted on crankshaft 20 and is configured to transfer torque to outer races 110 through rollers 112. Hub 102 is disposed about, and may be centered on, axis 22. Hub 102 has an annular radially outwardly projecting flange 134 intermediate the axial ends 136, 138 of hub 102. Flange 134 defines shoulders against which bearings 106, 108 are disposed. Flange 134 also creates a stepped outer diameter that defines an inner raceway 140 and first and second inner bearing surfaces 142, 144 on either side of raceway 140. The outer diameter of hub 102 at bearing surface 142 is less than the outer diameter of hub 102 at bearing surface 144. Hub 102 tapers towards end 136 and includes portions 146, 148 with varying outer diameters that define a shoulder. Portion 146 is sized to receive hub 126. Referring to FIG. 6, portion 148 defines a plurality of apertures 150 configured to receive fasteners 132 that enable hub 126 to be locked to driven member 104 as discussed in greater detail hereinbelow. Referring to FIG. 7, portion 148 further defines a plurality of bores 152 configured to receive pins 128 that rotatably couple hubs 102, 126. Apertures 150 may be circumferentially spaced equidistant from one another. Similarly, bores 152 may be circumferentially spaced equidistant from one another and from apertures 150. Referring to FIG. 5, in the illustrated embodiment hub 102 includes six apertures 150 spaced 60 degrees from one another. Hub 102 may further include three bores 152 spaced 120 degrees from one another and 60 degrees from apertures 150. It should be understood, however, that the number and spacing of apertures 150 and bores 152 may vary. Portion 148 also defines a surface 154 extending perpendicular to axis 22 and engaged by set screws 130 to control the axial position of hub 126. Hub 102 defines a stepped diameter bore 156 configured to receive crankshaft 20. The smaller diameter portion of bore 156 is configured to received a threaded portion of crankshaft 20.

Pulley 104 is provided to transmit torque from outer races 110 to device 14 through belt 30 and pulley 26. Pulley 104 is supported on hub 102 by bearings 106, 108. Pulley 104 defines a plurality of grooves 158 in a radially outer surface configured to grip belt 30. Pulley 104 has a stepped inner diameter that defines a radially inner surface 160 radially spaced from inner raceway 140 and outer bearing surfaces 162, 164 disposed on either side of surface 160 and radially spaced from inner bearing surfaces 142, 144, respectively, of hub 102. The diameter of pulley 104 at surfaces 160, 164 is equal. The diameter of pulley 104 at bearing surface 162, however, is less than the diameter at surfaces 160, 164 and is about equal to the diameter of hub 102 at raceway 140. Pulley 104 defines a radially inwardly extending flange 166 at one axial end that extends around one axial end of bearing 106 and tapers complementary to the taper of hub 102. Flange 166 defines a groove 168 configured to receive a portion of hub 126. Groove 168 may be a circular groove.

Bearings 106, 108 are provided to allow relative rotation of pulley 104 and hub 102 in an overrunning condition. Bearings 106, 108 are conventional in the art and may comprise roller bearings. Bearing 106 is disposed between bearing surfaces 142, 162 while bearing 108 is disposed between bearing surfaces 144, 164 and is supported by bearing carrier 118.

Outer races 110 transfer torque from rollers 112 to pulley 104. Races 110 are disposed between surface 160 of pulley 104 and raceway 140 of hub 102 and include radially inner surfaces 170 opposing inner raceway 140. Referring to FIG. 9, the surface 170 of each race 110 defines a plurality of cam surfaces 172 spaced circumferentially about the race 110 and opposing raceway 140. In accordance with one aspect of the present invention, each cam surface 172 is configured to maintain a substantially constant grip angle between: (i) a corresponding roller 112 and surface 170 of outer race 110; and (ii) the roller 112 and inner raceway 140. The grip angle refers to the angle between (a) a straight line extending through the points of contact of roller 112 with raceway 140 and cam surface 172 and (b) a straight line extending through the center of roller 112 and the point of contact of roller 112 with raceway 140 or cam surface 172. The substantially constant grip angle helps to limit the impact of lubricant breakdown and torsional vibration from engine 12 on clutch 100. In accordance with another aspect of the present invention, each outer race 110 is press-fit into pulley 104. The press-fit relationship stiffens outer race 110 and preloads race 110 to prevent deflection of race 110 and skidding of rollers 112 and does so at a lower cost compared to conventional clutches. In accordance with another aspect of the present invention, the formation of cam surfaces 172 in outer races 110 and the location of rollers 112 and springs 114 in the pockets defined by cam surfaces 172 helps to reduce oscillation of the combined mass of the roller 112 and spring 114 and vibrational amplitude relative to clutches in which the rollers 112 and springs 114 are supported within pockets formed on the inner race (or hub 102). Races 110 may be separated by a spacer or retainer 174 that extends between raceway 140 and surface 160 of pulley 104.

Rollers 112 are provided to selectively transmit torque between hub 102 and races 110. Rollers 112 are conventional in the art and may be made from conventional metals and metal alloys. Rollers 112 may be circular in cross-section. Rollers 112 are not retained by a cage and clutch 100 is therefore a loose roller clutch. The use of rollers 112 rather than sprags and the loose configuration of rollers 112 rather than using a cage helps to limit the impact of lubricant breakdown and torsional vibration from engine 12 on clutch 100. Rollers 112 remain engaged with both inner raceway 140 and cam surfaces 172 as long as pulley 104 is rotating at the same speed, and in the same direction as hub 102. If pulley 104 begins to rotate at a higher speed than hub 102 or in a different direction, rollers 112 become disengaged from inner raceway 140 and races 110 and pulley 104 are able to freewheel relative to hub 102.

Springs 114 bias rollers 112 into engagement with cam surfaces 172. Springs 114 may comprise wave springs or other conventional springs. Springs 114 are inserted in the open space between the inner raceway 140 and cam surfaces 172 and centrifugal forces prevent springs 114 from contacting hub 102. In accordance with one aspect of the present invention, springs 114 act directly on rollers 112 as opposed to driving rollers 112 with spring energized plungers or a cage or other actuating members. This structure permits clutch 100 to better withstand the breakdown of lubricants such as grease and the potential impact of the grease on spring force thereby reducing the possibilities clutch 100 will seize or fail.

In accordance with one aspect of the present invention, rollers 112 are formed having a relatively low mass m and springs 114 are formed to have a relatively high spring constant k. As a result, the natural frequency n of the combined roller 112 and spring 114 system is relatively high in accordance with the following formula:

$$n = \sqrt{\frac{k}{m}}$$

The rollers 112 and springs 114 are selected to provide a natural frequency responsive to the characteristics of the operating environment, but preferably define a natural frequency of at least 300 Hz. In one preferred embodiment in which clutch 100 is used in the environment shown in FIG. 1, the rollers 112 and springs 114 are selected to provide a natural frequency of about 700 Hz. The use of a roller and spring system having a high naturally frequency represents a significant improvement as compared to conventional clutches. Because of the high natural frequency, the rollers 112 and springs 114 are less affected by vibrations from components in the operating environment (e.g., engine 12). As a result, clutch 100 may be used in high speed and/or high torque applications without requiring the clutch to be designed for excess torque capacity thereby enabling the use of smaller, lighter, and less expensive clutches. Referring to FIG. 1, clutch 100 can be designed relative to the smaller torque requirements of an accessory device 14 rather than being designed to carry the maximum torque load of engine 12.

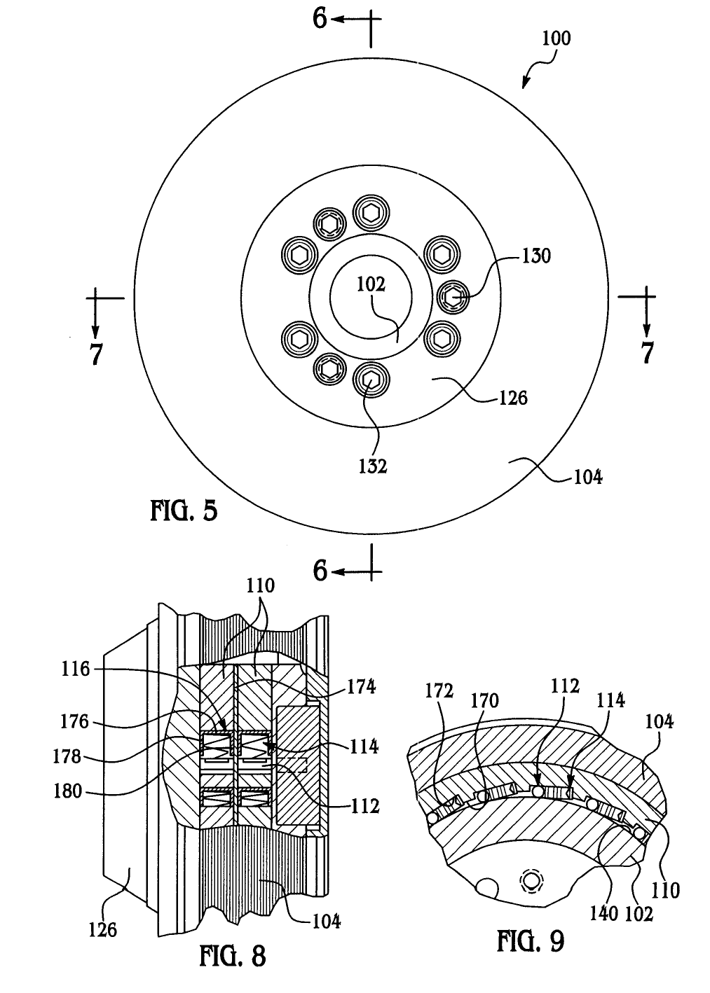

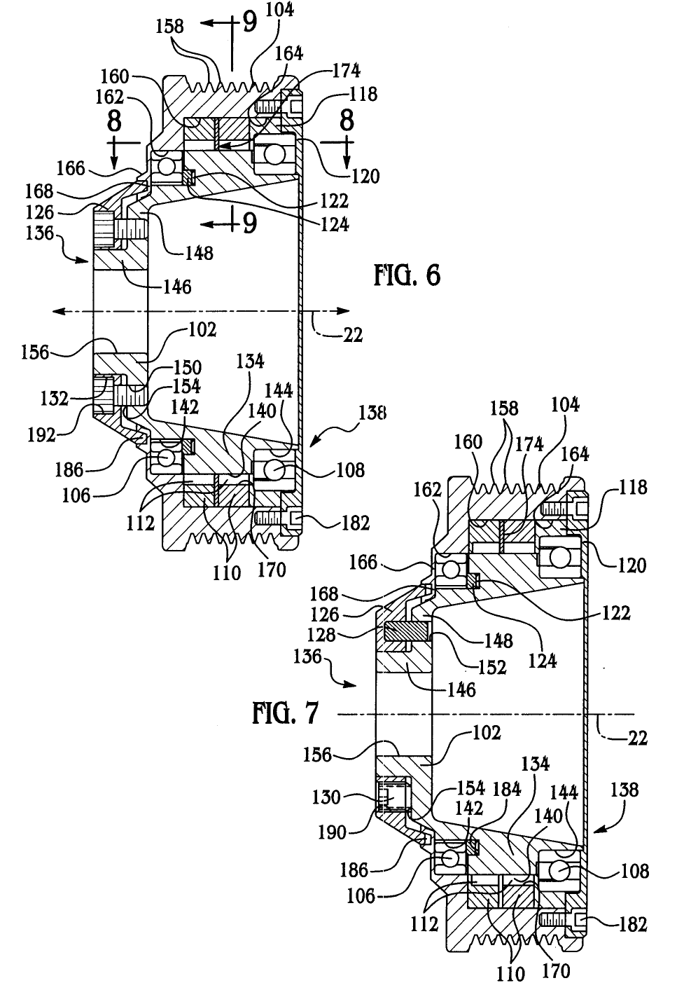

Spring retainers 116 are provided to limit movement of springs 114, to allow for adjustment of spring deflection in view of size/tolerance variations in the size of the pockets formed by cam surfaces 172, and to protect springs 114 from potential damage from rollers 112. Spring retainers 116 facilitate the use of stiffer springs 114 by enabling variation in spring deflection and by retaining springs 114 in position. Retainers 116 also protect springs 114 from damage due periodic popping of rollers 112. Referring to FIG. 8, each retainer 116 is substantially U-shaped. Each retainer 116 includes a base 176 that forms a spring seat for a corresponding spring 114 opposite a corresponding roller 112. Each retainer 116 further includes arms 178, 180 extending from base 176. Arms 178, 180 are configured to limit movement of spring 114 in a direction parallel to axis 22. Arms 178, 180 may extend from either axial end of base 176 and are disposed on either axial side of spring 114 (relative to axis 22). The width of each arm 178, 180 may taper toward one end remote from base 176 such that the gap between arms 178, 180 widens in order pilot springs 114 during compression. The distance between arms 178, 180 is less than the axial length of rollers 112 to prevent rollers 112 from crushing springs 114 during popping of rollers 112.

Bearing carrier 118 supports bearing 108 between hub 102 and pulley 104. Bearing carrier 118 is also provided to act as a seal to retain lubricant within clutch 100 while reducing the possible frictional impact of the seal and further serves to inhibit lubricant flow between bearing 108 and the working surfaces of clutch 100 (i.e., raceway 140, cam surfaces 172 and rollers 112) to prevent cross-contamination. Carrier 118 includes a radially inwardly extending flange that is disposed axially between rollers 112 and bearing 108 and axially between at least a portion of flange 134 of hub 102 and bearing 108. Carrier 118 also prevents rollers 112 (which again are loose rollers unrestrained by a cage) from contacting and sticking to bearing 108. Carrier 118 may be made from metal or metal alloys such as steel and may be coated with an anti-friction coating such as manganese phosphate (which also acts as a rust inhibitor).

End cap 120 provides structural support and positions components of clutch 100. End cap 102 may be annular in construction. End cap 120 defines a stepped diameter inner bore, forming a shoulder designed to engage a corresponding shoulder of the outer race of bearing 108. End cap 102 may be fastened to pulley 104 using conventional fasteners 182 such as screws, bolts or pins.

Springs 122 and plungers 124 are provided to apply a preload to bearing 106. Spring 122 and plungers 124 may be disposed circumferentially within recesses 184 formed in hub 102. Springs 122 may comprise Belleville washers. Springs 112 urge plungers 124 into engagement with, and apply a force to, an inner race of bearing 106 to preload bearing 106.

Hub 126 is provided to selectively lock hub 102 and pulley 104 to allow torque to be conveyed to pulley 104 (and accessory devices 14) in the event of clutch failure. Hub 126 is disposed about axis 22 and portion 146 of hub 102. The radially outer surface of hub 126 is conically shaped and terminates in a flange 186 that is configured to be received within groove 168 of pulley 104. Flange 186 is circular and is wedge shaped in cross-section such that flange 186 frictionally engages the surfaces of pulley 104 forming groove 168 when hub 126 is moved closer to pulley 104 to thereby lock hub 102 and pulley 104 together. Referring to FIG. 7, hub 126 defines a plurality of closed bores 188 configured to receive one end of a corresponding pin 128 through which hub 126 is coupled to hub 102 for rotation therewith. Referring to FIGS. 5-7, hub 126 also defines a plurality of apertures 190 and 192 extending therethrough. Referring to FIG. 7, apertures 190 are configured to receive set screws 130. Apertures 192 are configured to receive fasteners 132. Apertures 190 may be circumferentially spaced equidistant from one another. Similarly, apertures 192 may be circumferentially spaced equidistant from one another and from apertures 190. In the illustrated embodiment hub 126 includes three apertures 190 spaced 120 degrees from one another and six apertures 192 spaced 60 degrees from one another. It should be understood, however, that the number and spacing of apertures 190, 192 may vary.

Pins 128 are provided to rotatably couple hubs 102, 126. Pins 128 may be made from conventional metals or plastics and are received in aligned bores 152, 188 in hubs 102, 126.

Set screws 130 are provided to set the axial position of hub 126 relative to pulley 104 and thereby prevent or allow locking of hub 102 and pulley 104. Screws 130 extend through apertures 190 in hub 126 and engage surface 154 of portion 148 of hub 102 thereby urging hub 126 away from pulley 104 (to the left in FIGS. 6-7) and preventing flange 186 from being received in groove 168 of pulley 104.

Fasteners 132 are provided to bring hub 126 into engagement with pulley 104 when it is desired to lock pulley 104 to hub 102. Fasteners 132 are conventional in the art and may comprise screws, bolts or other fasteners. Fasteners 132 extend through apertures 192, 150 in hubs 126, 102.

A clutch in accordance with the present invention represents a significant improvement as compared to conventional clutches. The inventive clutch facilitates the use of grease lubrication in the clutch through improved lubricant retention and the use of an energizing mechanism (in the form of a loose roller mechanism) that better withstands degradation of the lubricant. An overrunning clutch in accordance with the present invention also allows use overrunning clutches in high speed and/or high torque applications without requiring the clutch to be designed for excess torque capacity thereby enabling the use of smaller, lighter, and less expensive clutches.

While the invention has been shown and described with reference to one or more particular embodiments thereof, it will be understood by those of skill in the art that various changes and modifications can be made without departing from the spirit and scope of the invention.

I claim:

1. An overrunning clutch, comprising:
a first hub disposed about an axis of rotation and defining an inner raceway;
a driven member supported on said first hub by a first bearing, said driven member defining a radially inner surface spaced from said inner raceway;
an outer race disposed between said radially inner surface of said driven member and said inner raceway of said first hub, said outer race having a radially inner surface defining a plurality of cam surfaces opposing said inner raceway;
a plurality of rollers disposed between said inner raceway and said outer race; and,
a plurality of springs, each spring of said plurality of springs urging a corresponding roller into engagement with a corresponding cam surface in said outer race
wherein a first roller of said plurality of rollers has a relatively low mass and a first spring of said plurality of springs has a relatively high spring constant such that a natural frequency of the combined system defined by said first roller and said first spring is at least 300 Hz.

2. The overrunning clutch of claim 1, further comprising a plurality of spring retainers, each spring retainer of said plurality of spring retainers having a base forming a spring seat for a corresponding spring of said plurality of springs and first and second arms extending from said base and disposed on opposite axial sides of said corresponding spring.

3. The overrunning clutch of claim 1, further comprising a second hub connected to said first hub for rotation therewith, said second hub configured for selective engagement with said driven member.

4. The overrunning clutch of claim 3 wherein said driven member includes a groove and said second hub includes a flange configured to be received within said groove upon engagement with said driven member.

5. The overrunning clutch of claim 3, further comprising a set screw extending through an aperture in said second hub and engaging said first hub wherein rotation of said set screw controls a position of said second hub relative to said driven member.

6. The overrunning clutch of claim 1, further comprising a preload spring applying a preload to said first bearing.

7. The overrunning clutch of claim 1, further comprising a first seal disposed axially between said rollers and said first bearing.

8. The overrunning clutch of claim 1 wherein said inner raceway, said plurality of cam surfaces, said rollers and said first bearing are lubricated with grease.

9. The overrunning clutch of claim 1 wherein said driven member comprises a pulley.

10. The overrunning clutch of claim 1 wherein each cam surface of said plurality of cam surfaces in said outer race is configured to maintain a substantially constant grip angle between a corresponding roller of said plurality of rollers and said outer race.

11. A power transmission assembly, comprising:
an internal combustion engine, a shaft extending from said engine and configured for rotation about a rotational axis;
an accessory device;
an accessory mounted clutch mounted to said accessory device and selectively transmitting torque from said shaft of said engine to said accessory device;
an overrunning clutch, including:
a first hub disposed about an axis of rotation and defining an inner raceway;
a driven member supported on said first hub by a first bearing, said driven member defining a radially inner surface spaced from said inner raceway;
an outer race disposed between said radially inner surface of said driven member and said inner raceway of said first hub, said outer race having a radially inner surface defining a plurality of cam surfaces opposing said inner raceway;
a plurality of rollers disposed between said inner raceway and said outer race; and,
a plurality of springs, each spring of said plurality of springs urging a corresponding roller into engagement with a corresponding cam surface in said outer race
wherein a first roller of said plurality of rollers has a relatively low mass and a first spring of said plurality of springs has a relatively high spring constant such that a natural frequency of the combined system defined by said first roller and said first spring is at least 300 Hz.

12. The power transmission assembly of claim 11 wherein said overrunning clutch further includes plurality of spring retainers, each spring retainer of said plurality of spring retainers having a base forming a spring seat for a corresponding spring of said plurality of springs and first and second arms extending from said base and disposed on opposite axial sides of said corresponding spring.

13. The power transmission assembly of claim 11 wherein said overrunning clutch further includes a second hub connected to said first hub for rotation therewith, said second hub configured for selective engagement with said driven member.

14. The power transmission assembly of claim 13 wherein said driven member includes a groove and said second hub includes a flange configured to be received within said groove upon engagement with said driven member.

15. The power transmission assembly of claim 13 wherein said overrunning clutch further includes a set screw extending through an aperture in said second hub and engaging said first hub wherein rotation of said set screw controls a position of said second hub relative to said driven member.

16. The power transmission assembly of claim 11 wherein said overrunning clutch further includes a preload spring applying a preload to said first bearing.

17. The power transmission assembly of claim 11 wherein said overrunning clutch further includes a first seal disposed axially between said rollers and said first bearing.

18. The power transmission assembly of claim 11 wherein said inner raceway, said plurality of cam surfaces, said rollers and said first bearing of said overrunning clutch are lubricated with grease.

19. The power transmission assembly of claim 11 wherein said driven member of said overrunning clutch comprises a pulley.

20. The power transmission assembly of claim 11 wherein each cam surface of said plurality of cam surfaces in said outer race is configured to maintain a substantially constant grip angle between a corresponding roller of said plurality of rollers and said outer race.
